(19) United States
(12) Patent Application Publication
(10) Pub. No.: US 2006/0136504 A1
(43) Pub. Date: Jun. 22, 2006

(54) Combined analysis of statistical and performance data in a computer based enterprise application environment

(76) Inventors: Dieter Babutzka, Muehlhausen (DE); Dominic P.O. Hehn, Nussloch (DE); Pavel A. Luginets, Heidelberg (DE); Uwe W. Bloching, Nussloch (DE)

Correspondence Address: FISH & RICHARDSON, P.C., PO BOX 1022, MINNEAPOLIS, MN, 55440-1022, US

(21) Appl. No.: 11/015,979

(22) Filed: Dec. 17, 2004

(51) Int. Cl. G06F 17/30

(52) U.S. Cl. 707/201

(57) ABSTRACT

Methods and apparatus, including computer program products, implement techniques for the combined analysis of application-based statistical data and system-usage-based performance data for a distributed enterprise system. The performance data represents utilization of a system resource in the distributed enterprise system. The statistical data represents cost of particular application program steps executed on the distributed enterprise system. A user requested view of the performance data is displayed. User input is received selecting a view item of the one or more view items in the displayed view. A user gesture is received selecting a predefined link for the selected view item. Selecting the link causes a predefined query associated with the link to be performed on the statistical data. The query is performed with parameter values based on data items of the selected view items, and the result of running the query on the statistical data is displayed.

### BACKGROUND

The present invention relates to data processing by digital computer, and more particularly to combined analysis of application-based statistical data and system-usage-based performance data.

Prior to the growth of client-server computing, a mainframe computing environment was typically used for running business applications. The mainframe computing environment includes a mainframe computer and one or more user devices. Typically, the user devices were “dumb terminals” with virtually no processing power and all the processing required by a business application, including the processing required to implement a user interface for the business application, was performed on the mainframe computer. In such a mainframe computing environment it was relatively simple to analyze performance characteristics of the business application and the usage of system resources by the business application. The number of users interacting with the business application was well defined. In addition, information regarding user sessions for each user and information regarding the applications competing for system resources could be easily captured and made available at the mainframe computer.

Typically a distributed enterprise system is used for running enterprise applications. The distributed enterprise system includes a widely dispersed distributed computing system and a large number of computer systems located in a number of geographical locations. Enterprise data required by an enterprise application can also be stored in a number of geographical locations. Users of the enterprise application are located at different sites worldwide but the users have access to the same enterprise data and enterprise applications. Typically, a user does not know where the data accessed by the user is geographically located and which computer systems in the enterprise computing system is being used to run the user's enterprise application. In addition, tasks required to be performed by the enterprise application are performed on multiple computer systems.

A three-tiered client-server architecture is commonly used to implement a distributed enterprise system. The three-tiered architecture separates the computer systems that make up the enterprise computing systems into three functional groups—presentation servers, application servers, and database servers. The database servers implement a database that stores the enterprise data. The application servers implement the processing logic of the enterprise system and are used to run the enterprise applications. In addition, the application servers implement services required by the users of the enterprise system, e.g., spooling, printing, dispatching user requests, and formatting data. The presentation servers handle tasks related to presentation of the enterprise data.

An alternative multi-layer client-server architecture includes multiple clusters of computer systems, each cluster made up of one or more computer systems. The clusters are separated into three functional groups, where each cluster provides one type of service, i.e., presentation service, application service, or database service. In addition, one or more of the clusters can provide more than one type of service. For example, clusters providing more than one type of service are used to implement load balancing to ensure that all the computer systems in the enterprise system are being fully utilized. In addition, clusters providing more than one type of service are used to implement failover strategies where user requests directed to a failed cluster are directed to another cluster in the enterprise system.

The performance characteristics of an enterprise application running in a widely dispersed distributed computing environment are determined by characteristics of the individual computer systems that are used to run the enterprise application, as well as characteristics of network connections between the individual computer systems. Typically, the user of the enterprise application does not know which computer systems are performing the user requested services, and information required to analyze performance problems perceived by the user is not readily available at the user location. In addition, because different computer systems may be used at different times to perform the services requested by the user, it is difficult to reproduce a performance problem for the purposes of analysis.

### SUMMARY OF THE INVENTION

In general, in one aspect, the invention provides methods and apparatus, including computer program products, implementing techniques for the combined analysis of application-based statistical data and system-usage-based performance data. The techniques include collecting system-usage-based performance data and application-based statistical data for a distributed enterprise system, and displaying a user requested view of the performance data. The performance data represents utilization of a system resource in the distributed enterprise system at particular times, and the statistical data represents costs of particular application program steps executed on the distributed enterprise system at those particular times. The displayed view has one or more view items. The techniques further include receiving user input selecting one of the view items in the displayed view, receiving a user gesture selecting a predefined link having an associated query, and displaying a result of running the query on the statistical data. The selected view item has one or more data items, and selecting the link causes the query to be performed on the statistical data with parameter values based on the data items of the selected view items.

Advantageous implementations of the invention include one or more of the following features. The techniques further include receiving user input selecting a performance query of one or more predefined performance queries for the performance data, and displaying the results of running the selected performance query. The performance data includes CPU utilization, memory usage, and network usage. The statistical data includes the elapsed time for running the application program, and the CPU time for running the application program. Displaying the performance data includes displaying the performance data corresponding to a time interval, and displaying the performance data corresponding to specified instants of time. The techniques further include receiving a user gesture selecting a link of the plurality of links between the displayed performance data and the statistical data, where each link has a parameterized query identifying data items to be used as query parameters. Selecting the link causes the identified data items to be filled in with the associated data items for the selected items, and the result of running the parameterized query on the statistical data is displayed.

In another aspect, the invention provides methods and apparatus, including computer program products, implementing techniques for the combined analysis of application-based statistical data and system-usage-based performance data. The techniques include collecting system-usage-based performance data and application-based statistical data for a distributed enterprise system, and displaying a user requested view of the statistical data. The performance data represents utilization of a system resource in the distributed enterprise system at particular times, and the statistical data represents costs of particular application program steps executed on the distributed enterprise system at those particular times. The displayed view has one or more view items. The techniques further include receiving user input selecting one of the view items in the displayed view, receiving a user gesture selecting a predefined link having an associated query, and displaying a result of running the query on the performance data. The selected view item has one or more data items, and selecting the link causes the query to be performed on the performance data with parameter values based on the data items of the selected view items.

In another aspect, the invention provides methods and apparatus, implementing techniques for displaying a view of system-usage-based performance data for a distributed enterprise system, receiving a single user input gesture applied to one of the view items, where the single user input gesture selects a predefined link for the selected item, and displaying query results obtained from running a parameterized query associated with the predefined link on application-based statistical data. Performance data represents a utilization of a system resource in the distributed enterprise system at a particular time. The displayed view of the performance data has one or more view items. The parameterized query associated with the predefined link identifies data items to be used as query parameters, and selecting the link causes the identified data items to be filled in with the associated data items. The statistical data represents a cost of running an application program for a user session on the distributed enterprise system. The query results obtained from running the parameterized query on statistical data are displayed in response to the gesture.

Advantageous implementations of the invention include one or more of the following features. The techniques further include receiving a mouse down event over the selected view item, displaying a context menu in response to the mouse down event, and selecting the predefined link from the displayed context menu in response to receiving a mouse up event. Receiving the single user input gesture includes dragging the selected view item to a displayed user interface element representing the statistical data. The performance data includes CPU utilization, memory usage, and network usage. The statistical data includes the elapsed time for running the application program, and the CPU time for running the application program.

In another aspect, the invention provides methods and apparatus, implementing techniques for displaying a view of application-based statistical data for a distributed enterprise system, receiving a single user input gesture applied to one of the view items, where the single user input gesture selects a predefined link for the selected item, and displaying query results obtained from running a parameterized query associated with the predefined link on system-usage-based performance data. Statistical data represents a cost of running an application program for a user session on the distributed enterprise system. The displayed view of the statistical data has one or more view items. The parameterized query associated with the predefined link identifies data items to be used as query parameters, and selecting the link causes the identified data items to be filled in with the associated data items. The performance data represents an utilization of a system resource in the distributed enterprise system at a particular time. The query results obtained from running the parameterized query on performance data are displayed in response to the gesture.

Implementations of the invention can realize one or more of the following advantages. Performance problems for the distributed enterprise system can be analyzed and the reason for the performance problems can be discovered efficiently by combining the analysis of system-usage-based performance data and application-based statistical data. The use of predefined gestures having associated queries to navigate between the system-usage-based performance data and the application-based statistical data provides a user interface that is easy to use for analyzing performance problems. Users can define views of the system-usage-based performance data and application-based statistical data in accordance with user-defined requirements and navigate between the views using the predefined gestures. Users can also use user-specified gestures to navigate between the views, where the user-specified gestures have associated queries that are specified by the user. Any number of gestures can be defined between the system-usage-based performance data and the application-based statistical data. One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1 illustrates an environment for the combined analysis of system-usage-based performance data and application-based statistical data.

FIG. 2 is a flow diagram illustrating the combined analysis of system-usage-based performance data and application-based statistical data.

FIG. 3A illustrates an example of a user requested view of the system-usage-based performance data.

FIG. 3B illustrates an example of a view of the application-based statistical data generated by selecting a predefined link.

Like reference numbers and designations in the various drawings indicate like elements.

### DETAILED DESCRIPTION

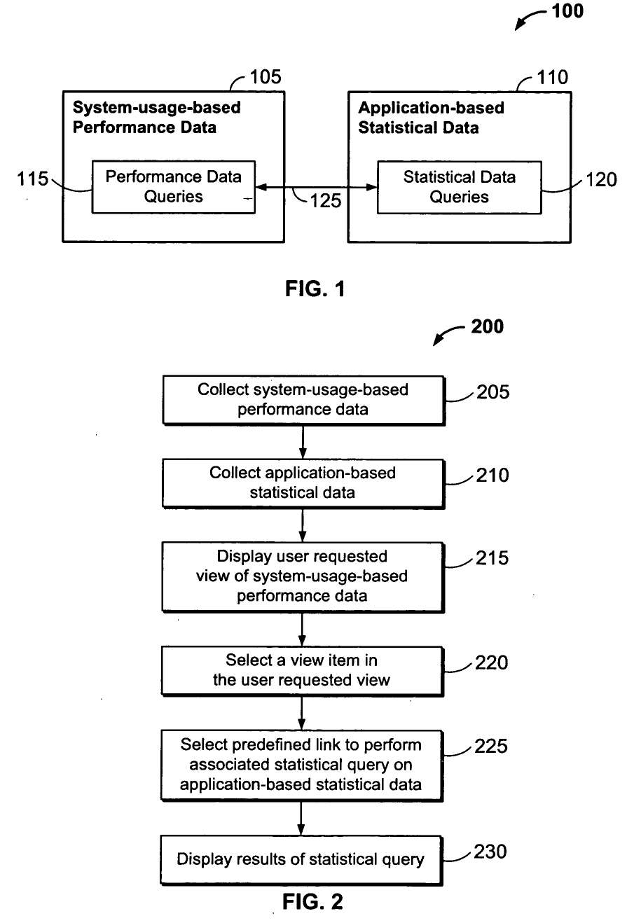

FIG. 1 illustrates an environment for combined analysis of system-usage-based performance data 105 and application-based statistical data 110. The system-usage-based performance data 105 includes information regarding the usage of enterprise system resources over a period of time. The application-based statistical data 110 includes information regarding the performance of enterprise applications running on the enterprise system. The system-usage-based performance data 105 and the application-based statistical data 110 are collected for the enterprise system and stored in distinct repositories. The system-usage-based performance data is analyzed using predefined performance data queries 115, and the application-based statistical data is analyzed using predefined statistical data queries 120. A user requests a customized view of the system-usage-based performance data by specifying one or more parameters for a predefined performance data query and requesting a report. The user requests a customized view of the application-based statistical data by specifying one or more parameters for a predefined statistical data query and requesting a report.

Combined analysis of the system-usage-based performance data and the application-based statistical data is performed in response to user input specifying one or more predefined links 125 between the system-usage-based performance data and the application-based statistical data. The predefined links can be specified in both directions, i.e., links from the system-usage-based performance data to the application-based statistical data, links from the application-based statistical data to the system-usage-based performance data. Each predefined link from the system-usage-based performance data to the application-based statistical data has an associated statistical data query. The user selects a predefined link to perform the associated statistical data query on the application-based statistical data using user specified parameters. The user can specify the parameters for the statistical data query by highlighting one or more data fields in the user requested view of the system-usage-based performance data, e.g., highlighting a row of the data. The user can select the predefined link using a user gesture such as performing a drag and drop movement using a mouse, or displaying a pop-up menu with available predefined links by clicking a mouse button and selecting one of the predefined links from the pop-up menu. Similarly, if the user selects a predefined link from the application-based statistical data to the system-usage-based performance data, a performance data query associated with the selected predefined link is performed using one or more user specified parameters.

System-usage-based performance data provides information regarding the usage of enterprise system resources over a period of time. System-usage-based performance data includes data regarding processor utilization, memory utilization, disk utilization, and network utilization that is collected for the entire enterprise system. System-usage-based performance data can be used for identifying and resolving performance problems caused by a particular computer system in the enterprise system, or by a particular network connection.

Application-based statistical data provides information regarding the performance of the enterprise applications running on the enterprise system over a period of time. Application-based statistical data for an enterprise application includes information identifying the application servers used to run the enterprise application, identity of users running the application, the start and end times for the processing performed for the enterprise application for each application server, the amount of data transmitted for the enterprise application and the network resources used to transmit the data, and the memory utilization and processor utilization for the enterprise application. The processing tasks required by the enterprise application can be performed using one or more system resources. The application-based statistical data also includes information regarding the system resources that are used by the enterprise application.

FIG. 2 is a flow diagram 200 illustrating a method for combining the analysis of system-usage-based performance data and application-based statistical data. The system-usage-based performance data is collected for the distributed enterprise systems at particular times (step 205). The application-based statistical data is collected for the enterprise applications running on the distributed enterprise system (step 210). A user requested view of the system-usage-based performance data is displayed, where the user requested view includes one or more view items (step 215). Each view item has one or more data items. One of the view items in the displayed user requested view is selected based on received user input (step 220). A predefined link from the system-usage-based performance data to the application-based statistical data is selected based on a received user gesture, and the statistical query associated with the predefined link is performed on the application-based statistical data (step 225). The statistical query associated with the selected link is performed using parameter values based on the data items of the selected view item, and the query results are displayed (step 230).

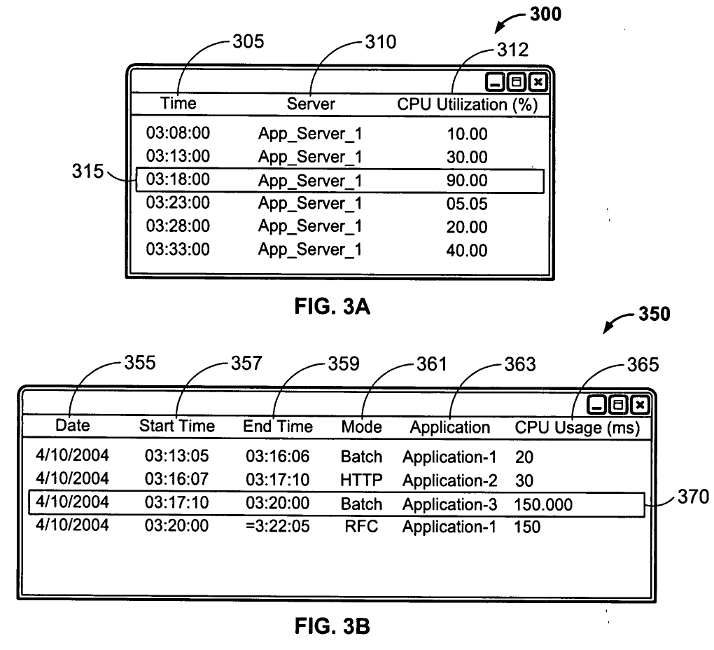

FIG. 3A illustrates an example of a user requested view 300 of system-usage-based performance data. The user requested view 300 is the report generated as a result of performing a user requested query for the CPU utilization of APP_SERVER_1 during a specified time period. The view 300 has three columns, where the third column 312 displays percentage CPU utilization 310 of App_Server_1 at time instants listed in the first column 305. The second column 310 displays the name of the application server, i.e., App_Server_1. A very high percentage CPU utilization in the view 300, e.g., the 90% CPU utilization in row 315, can indicate the existence of potential performance problems. In order to analyze the performance problem, the user selects the row 315 and performs a predefined query on the application-based statistical data by selecting one of the available predefined links.

FIG. 3B illustrates an example of a view 350 of the application-based statistical data that is generated when the user selects a predefined link. The user selected predefined link is associated with a statistical query that displays all the applications and work processes running on an application server during a specified time interval. The parameters required for performing the query are generated automatically based on the user selected view item in the view 300 of the system-usage-based performance data. For example, the system identifier, the application server identifier, the date, and the time can be provided to the statistical query. The view 350 generated as a result of performing the associated statistical query shows the date 355, start time 357, end time 359, program mode 361 (e.g., BATCH, HTTP, or RFC), name of the application 363 running on APP_SERVER_1 at the specified date 355 and time 357, 359, and percentage CPU usage in milliseconds 365. The view 350 can be used to identify a particular application responsible for the performance problem. For example, the third row 370 of the view 350 may indicate the source of performance problem because it shows that APPLICATION_3 consumed 150,000 milliseconds of CPU time during the associated time interval.

In one implementation, the combined analysis of system-usage-based performance data and application-based statistical data is implemented using a data warehouse such as SAP Business Warehouse available for SAP AG of Walldorf (Baden), Germany. The system-usage-based performance data and the application-based statistical data are collected for the distributed enterprise system and extracted into the data warehouse. The data warehouse is used to define performance data queries and statistical data queries for the system-usage-based performance data and the application-based statistical data respectively. In addition, links between the queries for the system-usage-based performance data and the application-based statistical data are defined using the data warehouse. Each defined link has an associated query that is performed using parameters based on a user selected view item.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the operations of the invention can be performed in a different order and still achieve desirable results. Other embodiments are within the scope of the following claims

What is claimed is:

1-21. (canceled)

22. A method comprising:
collecting system-usage-based performance data for a distributed enterprise system, the performance data representing utilization of a system resource in the distributed enterprise system at particular times;
collecting application-based statistical data for the distributed enterprise system, the statistical data representing costs of particular application program steps executed on the distributed enterprise system;
displaying a user requested view of first data, the displayed view having one or more view items, the first data being either the statistical data or the performance data;
receiving user input selecting one of the view items in the displayed view, the selected view item having one or more data items;
receiving a user gesture selecting a predefined link, the predefined link having an associated query, selecting the link causing the query to be performed on second data, the second data being the statistical data if the first data is the performance data, the second data being the performance data if the first data is the statistical data, the query being performed with parameter values based on the data items of the selected view item; and
displaying a result of running the query on the second data.

23. The method of claim 22, wherein:
the first data is the performance data and the second data is the statistical data.

24. The method of claim 22, wherein:
the first data is the statistical data and the second data is the performance data.

25. The method of claim 22, further comprising:
receiving user input selecting a query of one or more predefined queries for the first data; and
displaying results of running the selected query as the user requested view of the first data.

26. The method of claim 22, wherein the performance data comprises:
CPU utilization, memory usage, and network usage.

27. The method of claim 22, wherein the statistical data comprises:
the elapsed time for running the application program, and the CPU time for running the application program.

28. The method of claim 22, wherein displaying a view of the first data comprises:
displaying the first data corresponding to a time interval.

29. The method of claim 22, wherein displaying a view of the first data comprises:
displaying the first data corresponding to specified instants of time.

30. The method of claim 22, further comprising:
receiving a user gesture selecting a link of a plurality of links, the plurality of links being linked between the displayed first data and the second data, each link of the plurality of links having a parameterized query identifying data items to be used as query parameters, selecting the link causing the identified data items to be filled in with the associated data items for the selected item, each link being operable to run an associated query on the second data using one or more individual data items of the selected item; and
displaying a result of running the parameterized query on the second data.

31. A method for implementing a user interface, the method comprising:
displaying a view of first data for a distributed enterprise system, the first data being either system-usage-based performance data representing an utilization of a system resource in the distributed enterprise system at a particular time or statistical data representing a cost of running an application program for an user session on the distributed enterprise system, the displayed view of the first data having one or more view items;
receiving a single user input gesture applied to one of the view items, the single user input gesture selecting a predefined link for the selected item, the predefined link having a parameterized query identifying data items to be used as query parameters, selecting the link causing the identified data items to be filled in with the associated data items; and
displaying query results obtained from running the parameterized query in response to the gesture, selecting the link causing the query to be performed on second data, the second data being the statistical data if the first data is the performance data, the second data being the performance data if the first data is the statistical data.

32. The method of claim 31, wherein:
the first data is the performance data and the second data is the statistical data.

33. The method of claim 31, wherein:
the first data is the statistical data and the second data is the performance data.

34. The method of claim 31, wherein receiving the single user input gesture comprises:
receiving a mouse down event over the selected view item;
displaying a context menu in response to the mouse down event; and
selecting the predefined link from the displayed context menu in response to receiving a mouse up event.

35. The method of claim 31, wherein receiving the single user input gesture comprises:
dragging the selected view item to a displayed user interface element representing the second data.

36. The method of claim 31, wherein the performance data comprises:
CPU utilization, memory usage, and network usage.

37. The method of claim 31, wherein the statistical data comprises:
the elapsed time for running the application program, and the CPU time for running the application program.

38. A system comprising:
means for collecting system-usage-based performance data for a distributed enterprise system, the performance data representing utilization of a system resource in the distributed enterprise system at particular times;
means for collecting application-based statistical data for the distributed enterprise system, the statistical data representing costs of particular application program steps executed on the distributed enterprise system;
means for displaying a user requested view of first data, the displayed view having one or more view items, the first data being either the statistical data or the performance data;
means for receiving user input selecting one of the view items in the displayed view, the selected view item having one or more data items;
means for receiving a user gesture selecting a predefined link, the predefined link having an associated query, selecting the link causing the query to be performed on second data, the second data being the statistical data if the first data is the performance data, the second data being the performance data if the first data is the statistical data, the query being performed with parameter values based on the data items of the selected view item; and
means for displaying a result of running the query on the second data.

39. A system comprising:
means for displaying a view of first data for a distributed enterprise system, the first data being either system-usage-based performance data representing an utilization of a system resource in the distributed enterprise system at a particular time or statistical data representing a cost of running an application program for an user session on the distributed enterprise system, the displayed view of the first data having one or more view items;
means for receiving a single user input gesture applied to one of the view items, the single user input gesture selecting a predefined link for the selected item, the predefined link having a parameterized query identifying data items to be used as query parameters, selecting the link causing the identified data items to be filled in with the associated data items; and
means for displaying query results obtained from running the parameterized query in response to the gesture, selecting the link causing the query to be performed on second data, the second data being the statistical data if the first data is the performance data, the second data being the performance data if the first data is the statistical data.

40. A computer program product, tangibly embodied in an information carrier, the computer program product comprising instructions operable to cause data processing equipment to:
display a view of first data for a distributed enterprise system, the first data being either system-usage-based performance data representing an utilization of a system resource in the distributed enterprise system at a particular time or statistical data representing a cost of running an application program for an user session on the distributed enterprise system, the displayed view of the first data having one or more view items;
receive a single user input gesture applied to one of the view items, the single user input gesture selecting a predefined link for the selected item, the predefined link having a parameterized query identifying data items to be used as query parameters, selecting the link causing the identified data items to be filled in with the associated data items; and
display query results obtained from running the parameterized query in response to the gesture, selecting the link causing the query to be performed on second data, the second data being the statistical data if the first data is the performance data, the second data being the performance data if the first data is the statistical data.

41. The computer program product of claim 31, wherein:
the first data is the performance data and the second data is the statistical data.

42. The computer program product of claim 31, wherein:
the first data is the statistical data and the second data is the performance data.

43. The computer program product of claim 40, wherein the instruction for receiving the single user input gesture further comprise instructions operable to:
receive a mouse down event over the selected view item;
display a context menu in response to the mouse down event; and
select the predefined link from the displayed context menu in response to receiving a mouse up event.

44. The computer program product of claim 40, wherein the instruction for receiving the single user input gesture further comprise instructions operable to:
drag the selected view item to a displayed user interface element representing the second data.

45. The computer program product of claim 40, wherein the performance data comprises:
CPU utilization, memory usage, and network usage.

46. The computer program product of claim 40, wherein the statistical data comprises:
the elapsed time for running the application program, and the CPU time for running the application program.
